(19) United States
(12) Patent Application Publication
(10) Pub. No.: US 2002/0105429 A1
(43) Pub. Date: Aug. 8, 2002

(54) Bearing condition monitoring method and apparatus

(76) Inventors: John Lawrence Donner, Union City, PA (US); James Earl Holtgrefe, Erie, PA (US); Robert Burke Foster, Erie, PA (US)

Correspondence Address: GERALD W SPINKS, P. O. BOX 2330, PORT ORCHARD, WA, 98366, US

(21) Appl. No.: 10/039,287

(22) Filed: Jan. 4, 2002

Related U.S. Application Data
(63) Continuation of application No. 09/237,132, filed on Jan. 25, 1999.

(51) Int. Cl. G08B 21/00

(52) U.S. Cl. 340/682; 340/680

(57) ABSTRACT

A method and apparatus for monitoring the condition of an oil lubricated bearing based on the phenomenon that the bearing will operate at a reduced temperature for a limited time period after losing its flow of lubricating oil. The invention includes steps and means for comparing the bearing temperature to an average of similar bearing temperatures, and for generating a low temperature alarm when the bearing temperature drops more than a threshold amount. The setpoint of this threshold may be a function of the standard deviation of the temperatures of a plurality of similar bearings. The invention may include steps and apparatus for generating a high bearing temperature alarm and for communicating data to a remote location.

### CROSS REFERENCE TO RELATED APPLICATIONS

This is a continuation patent application of co-pending U.S. patent application Ser. No. 09/237,132, filed on Jan. 25, 1999, and entitled “Method and Apparatus for Monitoring the Condition of a Bearing.”

### STATEMENT REGARDING FEDERALLY SPONSORED RESEARCH OR DEVELOPMENT

Not Applicable

### BACKGROUND OF THE INVENTION

1. Field of the Invention

This invention relates generally to the field of on-line monitoring of rotating apparatus, and particularly to a method and apparatus for monitoring the loss of oil flow in an oil lubricated bearing in an electric motor.

2. Background Art

Oil lubricated bearings are well known in the art. Such bearings are commonly used, for example, in the electric traction motors that provide the drive power for train locomotives. It is also known that when the lubricating oil supply for such bearings is interrupted, the temperature of the bearing will experience an initial drop, before eventually rising to a level at which the bearing will fail prematurely.

The pinion end bearing of a locomotive traction motor (TM) is typically located in a gear case along with the drive gears. The gear case contains oil for lubricating and cooling the gears and bearing. If the oil is lost from the gear case due to a leak or seal failure, or if the flow of oil is lost to the bearing due to a blocked oil passage, the bearing will eventually fail due to mechanical damage. After loss of oil flow, it is known that there is a period of time during which the bearing can continue to operate, and in fact, in some applications, the temperature of the bearing will actually drop during this period. However, since the actual bearing temperature depends on many factors, including operating parameters and environmental conditions, actual bearing temperature drops can have a variety of causes. So, it is difficult to determine when oil flow is first lost in a bearing simply by monitoring the bearing temperature. Known systems which attempt to monitor and compare bearing temperatures typically only compare each bearing temperature with a reference temperature taken somewhere on the vehicle, such as on a frame, ignoring the fact that the frame temperature will not likely change according to load or environmental conditions in the same way a bearing temperature could be expected to change. Or, these known systems only compare the highest temperature reading from a set of bearings with the lowest temperature reading in that set, thereby possibly comparing only abnormally operating bearings. Further, known systems only monitor for an increase in the temperature of a bearing, when making this comparison; they do not monitor for a temperature drop in the bearing. So, these known systems fail to monitor for a bearing temperature drop below the temperature at which a bearing should operate, under a given set of changing operating conditions and changing environmental conditions. For example, the methods disclosed in U.S. Pat. No. 4,316,175 to Korber suffer from all of these deficiencies.

In some applications, it is possible to monitor the level of the oil in a gear case and to take timely corrective action in the event of the loss of oil. However, in many applications, including the pinion end bearing of a locomotive, the violent motion of the lubricating oil in the gear case precludes accurate level measurement.

Prior art bearing monitoring systems are known to include bearing temperature and bearing oil temperature monitors. A rise in the temperature of the bearing or bearing oil is often indicative of an abnormal condition which may involve bearing failure. However, in the event of a loss of lubricating oil, the measurement of oil temperature may become inaccurate and/or may not reflect the condition of the bearing. Furthermore, by the time there is an indicated rise in the temperature of the bearing itself, significant mechanical damage may have already occurred.

Accordingly, it is an object of this invention to provide a method and apparatus for monitoring the condition of a given oil lubricated bearing that will alert an operator to a loss of lubricating oil at a time well in advance of the onset of bearing damage, by comparing the temperature of the given bearing with an average temperature found in a set of bearings operating under the same operating and environmental conditons as the given bearing.

### BRIEF SUMMARY OF THE INVENTION

In order to achieve this and other objects of the invention, a method for monitoring the condition of an oil lubricated bearing is provided which includes: continuously measuring the operating temperatures of a plurality of bearings; continuously calculating a current, or running, average of the bearing temperatures; and generating an alarm signal when any one of the bearing temperatures first drops below the current average of the bearing temperatures by a selected threshold temperature difference.

Further, an apparatus is provided for monitoring the loss of lubricating oil in an oil lubricated bearing, including: a plurality of temperature sensors on a plurality of bearings, the temperature sensors generating a plurality of temperature signals corresponding to the operating temperatures of each of the bearings; a signal processor receiving the plurality of temperature signals, the processor being adapted to calculate a running, or current, average of the bearing temperatures; and a means for generating an alarm signal when any one of the bearing temperatures first drops below the current average of the bearing temperatures by a selected threshold temperature difference.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 illustrates the known phenomenon of bearing cooling upon the loss of lubricating oil flow;

FIG. 2 illustrates the calculated temperature drop expected to be experienced by a pinion end bearing of a locomotive traction motor upon the loss of its lubricating oil flow, for various power levels, and for various speeds;

FIG. 3 is a schematic illustration of an apparatus in accordance with the present invention for monitoring the loss of lubricating oil in bearings; and

FIG. 4 is a logic diagram according to the present invention, which can be incorporated in the operation of the processor of the apparatus of FIG. 3.

### DETAILED DESCRIPTION OF THE INVENTION

Although a rise in bearing temperature is commonly associated with bearing failure, a monitoring method or apparatus utilizing bearing temperature rise as its basis for alarm or action setpoints may not provide an operator with sufficient time to take corrective action prior to the occurrence of significant bearing damage. It has been found that, although a loss of lubricating oil to the pinion end bearing of a traction motor of a locomotive will result in a premature failure of the bearing, the failure will not occur immediately upon the loss of flow of lubricating oil. Rather, the bearing will continue to operate properly without damage for a significant amount of time, because of the residual oil film which remains on the bearing surfaces after loss of oil flow. Depending upon the conditions of operation of the bearing, such as bearing load and ambient temperature, this period of safe operation may extend for a significant duration.

In fact, during this period of safe operation without oil flow, the temperature of the pinion end bearing of a locomotive traction motor actually decreases from what it would otherwise have been with full lubrication flow.

This temperature drop phenomenon may be accentuated by the fact that the viscosity chosen for the lubricating oil of a pinion end bearing gear case is a compromise between the optimal viscosity for the bearing and the optimal viscosity for the gears, both of which are housed in the gear case. The oil typically chosen is thinner than optimal for the gears and thicker than optimal for the bearing; however, it is satisfactory for both. Because the oil is somewhat thicker than optimal for the bearing, heat is generated within the bearing under full lubrication conditions, as the oil is churned between the bearing and the race. When oil flow is lost, the bearing gradually clears itself of excess lubricating oil and begins to operate on a residual oil film, with the result that the amount of heat generated within the bearing is reduced. The operation of the bearing on the residual oil film causes no mechanical damage to the bearing, until the residual oil film is eventually depleted. When the residual oil film is depleted, the bearing fails because of metal-on-metal contact.

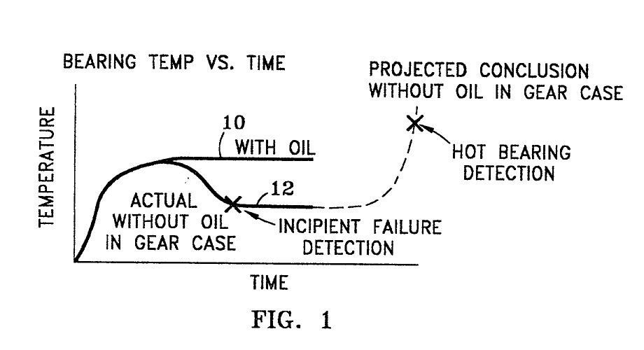

FIG. 1 illustrates this temperature drop phenomenon for a traction motor of a locomotive operating at full load at a train speed of 75 miles per hour. FIG. 1 is a graph of bearing temperature versus time, with Time on the X axis and Temperature on the Y axis. Curve 10 is a typical bearing temperature curve for the normal full lubrication condition. Curve 12 is a bearing temperature curve for an identical bearing, operating under identical conditions including the same oil, but on only residual oil, with no lubricating oil flow.

As can been seen from an inspection of FIG. 1, the fully lubricated bearing represented by temperature curve 10 gradually heats to a steady state temperature, which may be, for example, approximately 100 degrees C. The bearing operating on residual oil only, represented by curve 12, also gradually heats to nearly the same temperature, during which time the excess oil is being expelled from the bearing. Then, the bearing begins to cool after the excess lubricating oil is expelled from the bearing. This cooling signals the loss of lubricating oil flow. The time required to observe the cooling effect under actual operating conditions may be, in a typical bearing, approximately 100 minutes. The temperature of the bearing without lubricating oil flow eventually stabilizes at a temperature which is less than the steady state temperature of the bearing which is operating under the full lubrication condition. This lower steady state temperature may be, in a typical bearing, approximately 55 degrees C. The difference between steady state temperatures for the bearings with and without oil flow, then, would be approximately 45 Celsius degrees.

This approximate temperature difference will be maintained until the residual oil film is depleted in the bearing without oil flow, at which point mechanical damage begins to occur to the bearing surfaces. Mechanical damage to the bearing may not occur under these conditions until after, for example, approximately ten hours or more of operation without lubricating oil flow. During this period, the large temperature difference shown on FIG. 1 can be measured, thereby signaling the need for remedial action. For example, detection of the temperature difference between the steady state portions of curves 10 and 12, at the time noted by the X on curve 12, could give an early warning of the onset of bearing failure. The present invention, as discussed below, provides a method and apparatus which will give this early warning. Other bearing applications and other operating conditions may produce more or less of a difference in temperature between bearings operating under the full lubrication and residual lubrication conditions. Significantly, however, temperature measurements of traction motor pinion end bearings with and without oil flow are expected to yield a measurable temperature difference at varying locomotive speeds as low as approximately 35 miles per hour.

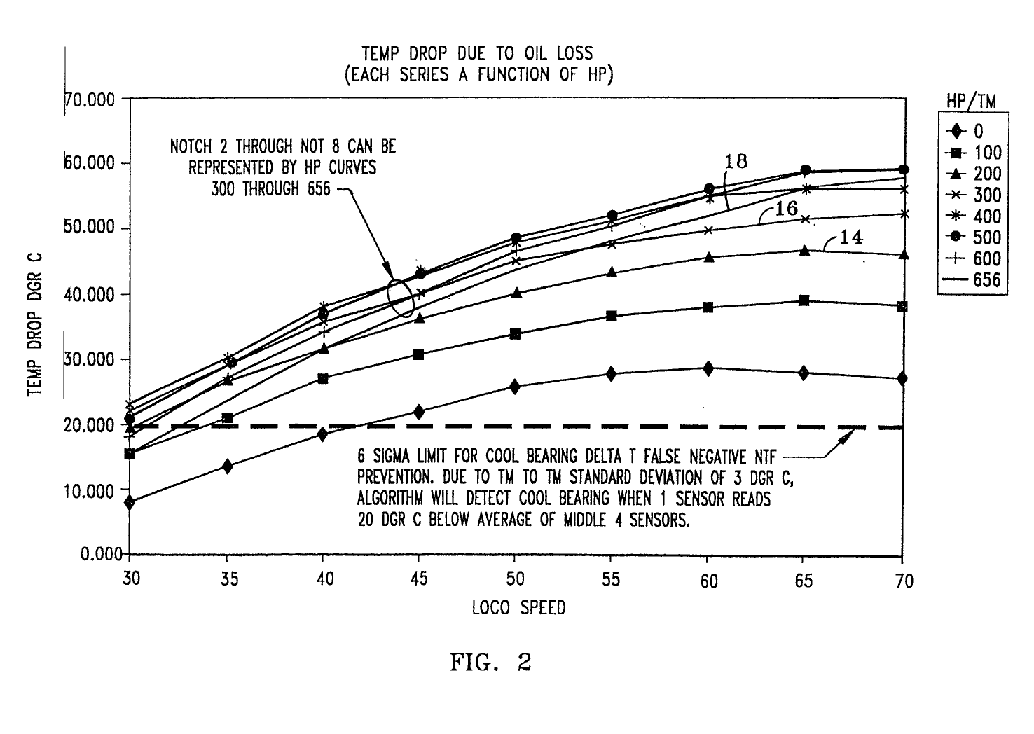

In FIG. 2, curves 14, 16, 18 plot the calculated temperature difference between the pinion end bearing temperature of a locomotive traction motor operating under fully lubricated conditions and the temperature of the same bearing operating with residual oil only. Curves 14, 16, 18 represent the temperature difference in the bearing at 200 horsepower, 300 horsepower and 656 horsepower, respectively. The X axis represents the speed of the locomotive, and the Y axis represents the drop in temperature between the fully lubricated and the residual lubrication conditions. The data of FIG. 2 results from a different set of tests than the data of FIG. 1, however, they are comparable and illustrate the same phenomenon. The temperature differences generated under these conditions for these motors are conveniently measurable with temperature measuring devices known in the art. As can be seen in FIG. 2, as long as the locomotive is operating at Notch 2 or higher, and as long as it is traveling at least 35 mph, a bearing which suffers loss of oil flow can be expected to experience an initial temperature drop of at least 20 Centigrade degrees. Significantly, these throttle notch and speed conditions are satisfied at least 90% of the time during normal motoring operations.

Although previously known, this temperature drop phenomenon has never been properly utilized in known systems by comparing the temperature of the given bearing with a temperature at which the given bearing would be expected to operate, under exactly the myriad of existing conditions to which the given bearing is subjected at any given point in time. More specifically, a means of determining the temperature at which the bearing could be expected to operate, under varying operating and environmental conditions, has heretofore not been properly identified. The present invention properly monitors the temperature of a given bearing by recognizing that, given a set of similar bearings operating under substantially identical conditions, if only one of the bearings loses oil flow, that bearing will experience a temporary drop in its operating temperature, as compared to the average temperature of the other bearings in the set which maintain full oil flow. During this time, the operating conditions of the bearings may change, even resulting in either an actual increase or decrease in the temperatures of all of the bearings, and an increase or decrease in the average bearing temperature. However, relative to the current average bearing temperature, the current temperature of the bearing which loses oil flow will drop. The present invention, for the first time, recognizes and utilizes this relationship between the current temperature of a given bearing and the current average temperature of a set of similarly situated bearings.

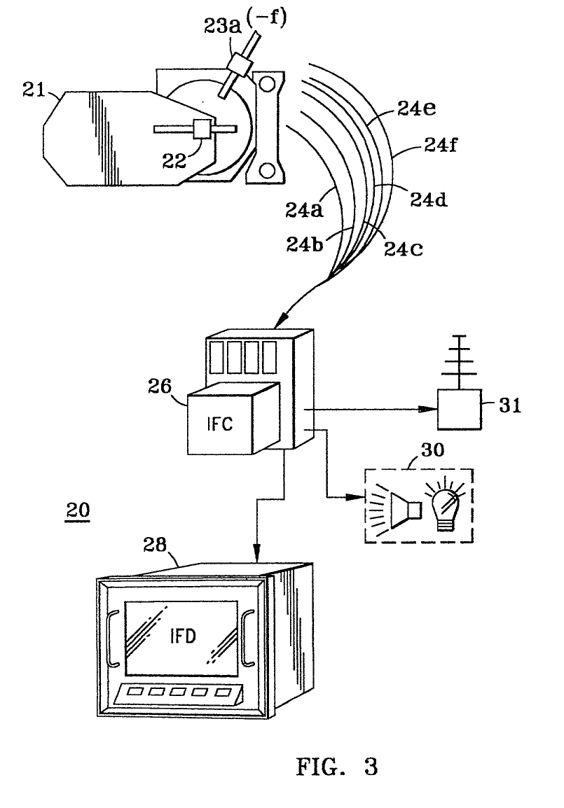

FIG. 3 illustrates an apparatus 20 for monitoring the condition of an oil lubricated bearing in accordance with the present invention. In FIG. 3, a motor 21 having a bearing 22 is illustrated as having a temperature sensor 23a associated with the bearing 22 for measuring the temperature of the bearing housing. The motor may be, for example, a traction motor for a locomotive, and the bearing may be the pinion end bearing in the traction motor. A plurality of similar motors are monitored by similar temperature sensors 23b-f, as for example in a locomotive having six traction motors, each with a monitored pinion end bearing. The temperature sensors may be any type known in the art, such as for example, General Electric Company Part Number 84A211110ACP1. The temperature sensors are operable to generate a plurality of temperature signals 24a-f corresponding to the temperatures of each of the bearings. The temperature signals 24a-f from the temperature sensors 23a-f are provided as inputs to a signal processor 26 such as an Integrated Function Computer (IFC) or microprocessor.

The IFC signal processor 26 is connected to a display such as an Integrated Function Display (IFD) 28, or other monitor and/or an alarm 30. The IFC signal processor 26 is operable to monitor the temperature signals 24a-f and to generate appropriate alarm signals to indicate off-normal operation of the bearings 22 by activating the IFD display 28 and/or the alarm 30. Signal processor 26 preferably includes software and/or hardware logic circuits for performing a variety of functions associated with the monitoring of the bearings 22 and alarming of off-normal conditions, and for logging and recording of temperature and alarm data.

FIG. 3 also illustrates a means for remote communication 31 connected to the signal processor 26. For an application on a train, this means may be a cellular telephone or other wireless communication apparatus or a device communicating via the rail lines or power lines. The means for remote communication 31 is capable of transmitting the bearing temperature data and alarm information off-board from the locomotive to a remote location, such as a central maintenance facility or rail yard. Alternatively, data from the bearing monitoring system 20 may be recorded on a magnetic disk for later transfer to an off-board data processing system.

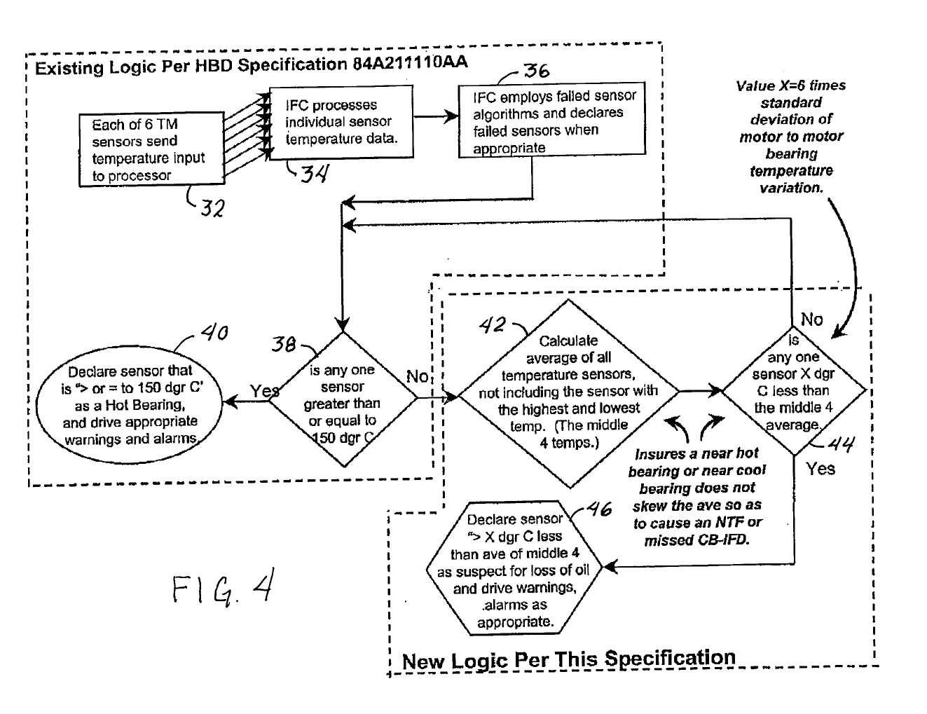

One embodiment of the logic that may be implemented in signal processor 26 is illustrated in FIG. 4. It is known in the art to operate such a processor to perform the steps shown in the upper-left dashed box, while the adaptation of such a processor to perform the steps shown in the lower-right dashed box, implementing the present invention, is new. The bearing temperature signals 24a-f are provided as input to the signal processor 26 at step 32 of FIG. 4. The signal processor 26 processes the individual sensor temperature data at step 34, and may employ a failed sensor algorithm at step 36 to evaluate the temperature signals to determine if any of the temperature sensors 23a-f has failed. If so, the signal from any failed sensor may be excluded from any further processing steps within the signal processor 26. The valid signals, from the non-failed sensors, are then analyzed for compliance with two types of limits. That is, in addition to monitoring for a cooler than normal bearing as will be explained below with regard to the steps shown in the lower dashed box, the signal processor 26 may also provide at step 38 a means for determining when the temperature of any bearing is greater than a predetermined upper temperature limit, such as for example 150 degrees C. If such a hot bearing is detected, appropriate warnings or alarms are generated at step 40.

If no hot bearing is detected in step 38, steps 42, 44, and 46 illustrate one embodiment of the logic process which can be incorporated in the present invention. This logic process monitors for incipient bearing failure due to a loss of lubricating oil flow, by monitoring for a drop in the temperature of one bearing, relative to the average temperature of all of the bearings. That is, when a bearing first becomes substantially cooler than it should otherwise be when operating under a given set of conditions such as load, speed, and lubrication, and in a given environment such as ambient temperature and wind conditions, it has become an abnormally “cool” bearing, indicating a likely loss of oil flow. The temperature at which a bearing would be expected to operate, under the given conditions, is essentially determined by continuously or repeatedly calculating the current average temperature of a set of similar bearings which are assumed to be operating essentially under the same given set of conditions. If the conditions change, such as a change in load in the motors, or if the environment changes, such as a change in ambient temperature, the current average temperature can be expected to change. When the current temperature of one of the bearings first becomes abnormally cooler than this current average temperature, this indicates that a loss in oil flow has likely occurred in that particular bearing. At this point, as will be explained below, the present invention provides warning of a Cool Bearing—Incipient Failure Detection (CB-IFD) condition.

In step 42, the signal processor 26 continuously or repeatedly calculates the average of the “valid” bearing temperatures, as represented by all of the temperature signals 24a-f, except for any temperature signal which may have been excluded in step 36 as the “invalid” signal of a failed sensor. Further, all of these valid temperature signals may be used, or alternatively, some of the valid temperature signals may be excluded from the calculation. For example, the highest valid temperature and the lowest valid temperature may be excluded. This would insure that the current average temperature is not skewed by inclusion of the temperature of a bearing which is nearing the high temperature limit, or by inclusion of the temperature of a bearing which is experiencing a temperature drop near the “cool” bearing temperature drop threshold. Inclusion of such temperature signals in the averaging step could result in a false No Trouble Found (NTF) result in the next step, constituting a missed CB-IFD condition.

In step 44 each individual valid bearing temperature is then continuously or repeatedly compared to the average temperature calculated in step 42. If an iteration of step 44 determines that any one of the current individual bearing temperatures has dropped more than a predetermined number of degrees below the current average temperature, a CB-IFD alarm or warning signal is generated in step 46. This predetermined temperature difference setpoint or threshold value may be a fixed number of degrees, or alternatively, it may be a function of the standard deviation of the plurality of valid bearing temperatures. In one embodiment, the setpoint may be equal to six times the standard deviation of the individual temperatures. The CB-IFD alarm signal generated in step 46 may be displayed in a variety of formats such as on an IFD display screen, as a warning light, or as an alarm bell, and/or it may be recorded in a memory function in the IFC signal processor 26 for later access and analysis.

The particular logic sequence incorporated in signal processor 26 can vary depending upon the design criteria established for the particular application, and the particular operating characteristics of the bearing(s) to be monitored. In particular, the importance of avoiding false positive (NTF) or false negative (CB-IFD) alarms will affect the way the input data is handled as well as the selection of the predetermined setpoint limits. Further, in an embodiment having only one bearing, the high temperature limit and the maximum temperature drop setpoint may be determined by design calculations, since there will be no similarly situated bearings from which actual on line comparisons can be made by comparison of the bearing temperature with an average temperature.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

We claim:

1. A method of monitoring the loss of lubricant at each of a plurality of oil lubricated bearings, said method comprising:
continuously sensing the temperature of each of a plurality of bearings;
continuously computing a current average of said temperatures of said plurality of bearings;
determining when said bearing temperature sensed at any of said bearings drops below said current average of said bearing temperatures;
identifying which said bearing experiences such temperature drop; and
generating an alarm signal when the magnitude of said temperature drop of such identified bearing relative to said average of said bearing temperatures is greater than a selected threshold temperature difference, thereby warning of a loss of lubrication in said identified bearing, prior to the onset of bearing damage.

2. The method of claim 1, further comprising generating a second alarm signal when any one of said bearing temperatures first exceeds a predetermined threshold temperature.

3. The method of claim 1, further comprising displaying a visual alarm in response to said alarm signal.

4. The method of claim 1, further comprising sounding an audible alarm in response to said alarm signal.

5. The method of claim 1, further comprising:
continuously evaluating signals from a plurality of temperature sensors associated with said plurality of bearings to determine if any of said temperature sensors has failed to generate accurate temperature measurement signals; and
excluding said temperature measurement signals generated by any such failed temperature sensor from said computation of said current average of said temperatures and from said determination of bearing temperature drop.

6. The method of claim 1, further comprising:
continuously determining the highest current bearing temperature and the lowest current bearing temperature; and
excluding said highest current bearing temperature and said lowest current bearing temperature from said computation of said current average of said temperatures.

7. The method of claim 1, further comprising:
continuously computing the current standard deviation of said plurality of bearing temperatures; and
selecting said threshold temperature difference as a function of said current standard deviation of said plurality of temperatures.

8. A method of monitoring the loss of lubricant from oil lubricated bearings in the traction motors of a locomotive prior to the onset of bearing damage, the method comprising:
providing a temperature sensor on each of a plurality of bearings;
continuously generating a temperature signal with each said sensor, each said signal being indicative of the current sensed operating temperature of one of said bearings;
communicating said temperature signals to a processor;
processing said temperature signals at said processor to continuously convert each said temperature signal to said current sensed bearing operating temperature, and to continuously calculate a current average of said sensed operating temperatures of said bearings;
determining when said sensed bearing operating temperature at any of said bearings drops below said current average of said sensed bearing operating temperatures;
identifying which said bearing experiences such temperature drop; and
generating an alarm signal when the magnitude of said temperature drop of such identified bearing relative to said current average of said bearing temperatures is greater than a selected threshold temperature difference, thereby warning of a loss of lubrication in said identified bearing, prior to the onset of bearing damage.

9. The method of claim 8, wherein said threshold temperature difference is selected to be 20 Celsius degrees.

10. The method of claim 8, further comprising:
operating said processor to continuously compute the current standard deviation of said sensed bearing operating temperatures; and
operating said processor to select said threshold temperature difference as a function of said standard deviation of said sensed bearing operating temperatures.

11. The method of claim 8, further comprising operating said processor to generate an alarm signal when any of said sensed bearing operating temperatures first exceeds a predetermined threshold temperature.

12. The method of claim 11, wherein said predetermined threshold temperature is selected to be 150 degrees Celsius.

13. The method of claim 8, further comprising:
operating said processor to continuously determine the highest current sensed bearing operating temperature and the lowest current sensed bearing operating temperature; and
excluding said highest current sensed bearing operating temperature and said lowest current sensed bearing operating temperature from said computation of said current average of said sensed bearing operating temperatures.

14. The method of claim 8, further comprising the step of communicating said alarm signal off-board of said locomotive.

15. A method of monitoring the loss of lubricant at each of a plurality of oil lubricated bearings prior to the onset of bearing damage, said method comprising:
continuously sensing the temperature of each of a plurality of bearings with a plurality of temperature sensors, each said sensor being associated with one of said plurality of bearings;
continuously evaluating signals from said plurality of temperature sensors to determine if any of said temperature sensors has failed to generate accurate temperature measurement signals;
identifying the temperature currently sensed by any said failed temperature sensor as an invalid temperature, with the remaining bearing temperatures being considered to be valid bearing temperatures;
continuously computing a current average of said valid temperatures of said plurality of bearings;
determining when the bearing temperature sensed at any of said bearings drops below said current average of said valid bearing temperatures;
identifying which bearing experiences such temperature drop;
continuously computing the current standard deviation of said plurality of valid bearing temperatures;
continuously selecting a threshold temperature difference as a function of said current standard deviation of said plurality of valid temperatures; and
generating an alarm signal when the magnitude of said temperature drop of said identified bearing relative to said average of bearing temperatures is greater than said selected threshold temperature difference, thereby warning of a loss of lubrication in said identified bearing, prior to the onset of bearing damage.

16. An apparatus for monitoring the loss of lubricant at each of a plurality of oil lubricated bearings prior to the onset of bearing damage, the apparatus comprising:
a plurality of temperature sensors, each said sensor being adapted to generate a temperature signal indicative of the current temperature of one of a plurality of bearings;
a processor adapted to receive said plurality of temperature signals and programmed to continuously calculate a current average of said current bearing temperatures;
circuitry adapted to determine when said bearing temperature sensed at any of said bearings drops below said current average of said bearing temperatures;
circuitry adapted to identify which bearing experiences such temperature drop; and
a signal generator adapted to generate an alarm signal when the magnitude of said temperature drop of such identified bearing relative to said average of said bearing temperatures is greater than a selected threshold temperature difference, thereby warning of the loss of lubrication in said identified bearing, prior to the onset of bearing damage.

17. The apparatus of claim 16, further comprising a signal generator adapted to generate an alarm signal when any one of said current bearing temperatures exceeds a predetermined threshold temperature.
